(19) United States
(12) Patent Application Publication
(10) Pub. No.: US 2026/0030665 A1
(43) Pub. Date: Jan. 29, 2026

(54) SYSTEM AND METHOD DETERMINING INDIVIDUAL STYLE PREFERENCE AND DELIVERING SAID STYLE PREFERENCES

(71) Applicant: Wantable, Inc., Milwaukee, WI (US)

(72) Inventors: Jalem Getz, Milwaukee, WI (US); Casey Sobrilsky, Milwaukee, WI (US)

(73) Assignee: Wantable, Inc., Milwaukee, WI (US)

(21) Appl. No.: 19/343,301

(22) Filed: Sep. 29, 2025

Related U.S. Application Data
(63) Continuation of application No. 16/512,663, filed on Jul. 16, 2019, now abandoned.
(60) Provisional application No. 62/698,616, filed on Jul. 16, 2018.

(51) Int. Cl. G06Q 30/0601; G06Q 30/0201; G06Q 30/0282

(52) U.S. Cl. CPC G06Q 30/0631; G06Q 30/0201; G06Q 30/0282; G06Q 30/0643

(57) ABSTRACT

The present invention is a system and method that improves a recommendation system's ability to determine a client's preference in clothing. The system not only receives direct client information though surveys, questionnaires, and client feedback, it also receives input based on a client's visual preferences. Through use of the stream, the client is shown pictures of articles of clothing and rates the articles. Based on the ratings, the system determines a client's visual preference and makes a final recommendation based on the client's visual preferences, which tend to be more accurate and complete than preferences achieved through textual responses.

### CROSS-REFERENCE TO RELATED APPLICATION

The present disclosure claims priority under 35 U.S.C. § 120 as a continuation of U.S. patent application Ser. No. 16/512,663 entitled “System and Method Determining Individual Style Preference and Delivering Said Style Preferences,” filed in the name of Getz et. al. on Jul. 16, 2019, now pending, which claims priority to U.S. Patent Application No. 62/698,616, filed on Jul. 16, 2018, entitled “System and Method Determining Individual Style Preference and Delivering Said Style Preferences,” which is incorporated herein by reference in its entirety.

### FIELD

The present disclosure is directed to a method for computer analysis, specifically a method of analyzing individual style preference based off pictorial representations and then delivering articles to an individual that comports with the individual's style preference.

### BACKGROUND

In a traditional retail apparel situation, a customer goes to a store, finds an article of clothing they want to purchase and then purchases the article of clothing. The same holds true for a purchase made in a traditional e-commerce apparel purchase. A customer browses the apparel website, selects an article of clothing they want to purchase, and then purchases the article of clothing. The common theme in the traditional apparel buying situation and the traditional e-commerce apparel buying situation is that the customer performs the work of picking out the article of clothing.

Recently, a number of non-traditional apparel buying businesses have started to emerge in the e-commerce realm. These non-traditional apparel buying businesses are centered around the concept of having a personal shopper who knows the customers style preferences and picks out the clothing for the customer. The customer receives the personal shopper's selections and determines which articles of clothing to keep.

Most of these non-traditional apparel buying businesses incorporate a recommendation system to assist personal shoppers in determining what inventory items to send to a customer. A recommendation system can learn about attributes and preferences of the client and narrow the inventory available to send to the client based on the attributes and preferences. The recommendation system then presents the personal shopper with the narrowed list of recommended inventory items for a client. Traditional recommendation systems for personal shoppers are only provided information on customers from textual descriptions provided by the customer about his/her preferences. For example, a customer will fill out a survey that asks if they like the color red, or if they like short sleeve shirts or the customer provides a profile update indicating that they do not like red any longer. The recommender then takes those attributes the customer has indicated about themselves and about what they have indicated they like and don't like and determines what inventory items to recommend. The list of inventory options available for the personal shopper to select from for that customer has now been reduced based on the results of the recommendation system.

However, customer surveys and feedback provide a limited and inadequate picture of customer preferences and a customer's actual likes and dislikes. Further these methods provide limited information to the recommender system. Typically, a customer will fill out a survey when they initially sign up for the service and are encouraged to update the profile information as it changes. However, that is a limited subset of information about a customer's preferences restricted by the survey contents. Further, while a customer might provide written feedback about a particular selection, most of these non-traditional apparel buying businesses are subscription services and provide new selections at most once per month. Feedback received regarding the selections will take a long time to develop any significant amount of information about a client's preference. Further, the information reported by the customer may be an inaccurate or incomplete indication of their personal preferences. For example, a customer may indicate they love red and love short sleeves, but they send back every red short sleeve shirt sent to them. This could be an issue of the system not being able to accurately capture the customers actual preference which may be that they love short sleeves and they love red, but they do not like them combined.

There is an unmet need in the art for a system and method capable of capturing a more detailed and accurate picture of a customer's personal preferences and doing so over a short period of time.

### SUMMARY

The present application overcomes the shortcomings of other recommendation systems by providing a method for customers to give an accurate indication of their personal preferences through the presentation of visual images to the customer where the customer provides a rating for the visual image.

In an exemplary embodiment a client will sign up for the personal stylist service. At the time a client signs up for the service the system will provide the client with a set of forms and questionnaires to fill out textually describing the client's preferences and other pertinent information pertaining to clothing fit. The information requested can include, but is not limited to, location, size, weight, height, color preferences, style preferences, sleeve preference, dress length preference, etc. The system stores this information in a client profile as direct client data. The client can directly make adjustments to his/her profile information at any time. A personal shopper or other employee will input inventory information into the system. The inventory information may include a picture of the item, a description of the item, a price for the item, attributes associated with the item, and any additional information about the item that may be useful for the system. The system will maintain a status regarding current inventory available for each item. Based on the client's direct data the system will determine an initial recommendation for the client out of the current inventory.

However, this is just the initial determination of recommended items made by the system. In addition to making a recommendation based off of information provided directly by the client, the system also includes a component called the stream. A client's interaction with the stream allows the system to gather a non-textual based representation of a client's preferences. This is important for getting better preference information from a client. For example, while a client may say they really like the color black and short sleeves, they may always return the short sleeve black shirts the system determines would be good recommendations for the client. Perhaps it is because while the client thinks they like short sleeve black shirts they really do not, or perhaps it is because while the client likes black and short sleeves, they do not like the combination together. This is information that cannot easily be gathered or determined from questionnaires or surveys. Further, to gather this information over time based on the items a client returns would take years of interaction where the client keeps receiving short sleeve black shirts they do not prefer. The stream enables the system to get real-time, reliable information about a client's preferences nearly instantaneously through the use of image presentation that is rated by the client.

In an embodiment, based off of the initial determination, the stream presents an image to the client. The client rates the image. The steam stores information about the rating and the image and associates it with the client's stream data. This process repeats until the client decides he/she is done rating images. The system analyzes the client stream data to make a determination on the client's preferences, not taking into account the client's direct information. Then, based on the initial recommendation determination, the system applies the client stream data analysis and makes a final recommendation on items for the client. The images presented to the client could be an article of clothing or multiple articles. The article(s) may be on a model or laid out. The image could be displayed on the screen as an image alone or could be displayed with additional information such as a title, a description of the article, price of the article, etc. The image could be a series of images shown in such a way that the client can scroll through and determine which images the client wants to rate. In an embodiment, the images shown to the client are based, at least in part, off of the initial determination. The images shown to the client may evolve each time after stream images are rated by the client. The rating could be a Boolean rating such as like or dislike, request or decline, etc. The rating could also be a scale rating wherein the user rates the degree to which they like or dislike the article. For example, the scale could be a rating of 1-5 where 5 is like the most and 1 is dislike the most and 3 is neutral. The rating received could be more than one rating if the client is shown and rates a series of images. Information on all items rated by the client will be associated with the client and re-analyzed each time the client rates another image. Accordingly, the more the client interacts with the stream, the more granularly the system can refine a client's preferences.

Through the showing and rating of images for articles of clothing, the system will be able to make a more accurate and detailed determination of the client's true preferences (and dislikes) than it could based merely on the direct client information. The fact that the client likes black shirts and likes short sleeves but does not like short sleeve black shirts will be determined by the system where questionnaires and surveys would not be able to determine that preference.

Once the final recommendation is determined, the system provides the recommendation to the personal shopper. The personal shopper then picks which items to send to the client based on the final recommendation from the system. The final recommendation may be provided to the personal shopper in any order. The final recommendation may be provided to the personal shopper such that the item that most closely matches the client's preferences is listed at the top and the item that least closely matches the client's preferences is listed at the bottom. The final recommendation may be provided to the personal shopper such that the item that most closely matches items the client has already kept is listed at the top and the item that least closely matches items the client has already kept is listed at the bottom.

When the client receives the items, the client decides which items to keep and which items to send back. Any items not received back by a predetermined date will be considered kept. The system will receive information about the items kept and returned and incorporate that information into the direct client data. Further, the client may provide direct feedback regarding the items. That information will also be provided to the system and incorporated into the direct client data. If the client does not choose to end the subscription service the process will repeat at a predetermined time. For example, a client might sign up for monthly shipments, weekly shipments, quarterly shipments, etc. The client can access the stream at any time after the initial subscription is started and the first initial preference determination is made.

The objects and advantages will appear more fully from the following detailed description made in conjunction with the accompanying drawings.

### BRIEF DESCRIPTION OF THE DRAWING(S)

FIG. 1 depicts an exemplary embodiment a system for providing a client with recommended items of clothing based on direct client data, stream data, and available inventory.

FIG. 2 depicts a flowchart a method for providing recommended items of clothing to a client based on direct client data, stream data, and available inventory.

FIG. 3 depicts an exemplary embodiment of a system for providing a client with recommended items of clothing based on direct client data, stream data, and available inventory.

### DETAILED DESCRIPTION OF THE DRAWING(S)

In the present description, certain terms have been used for brevity, clearness and understanding. No unnecessary limitations are to be applied therefrom beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. § 112, sixth paragraph, only if the terms “means for” or “step for” are explicitly recited in the respective limitation.

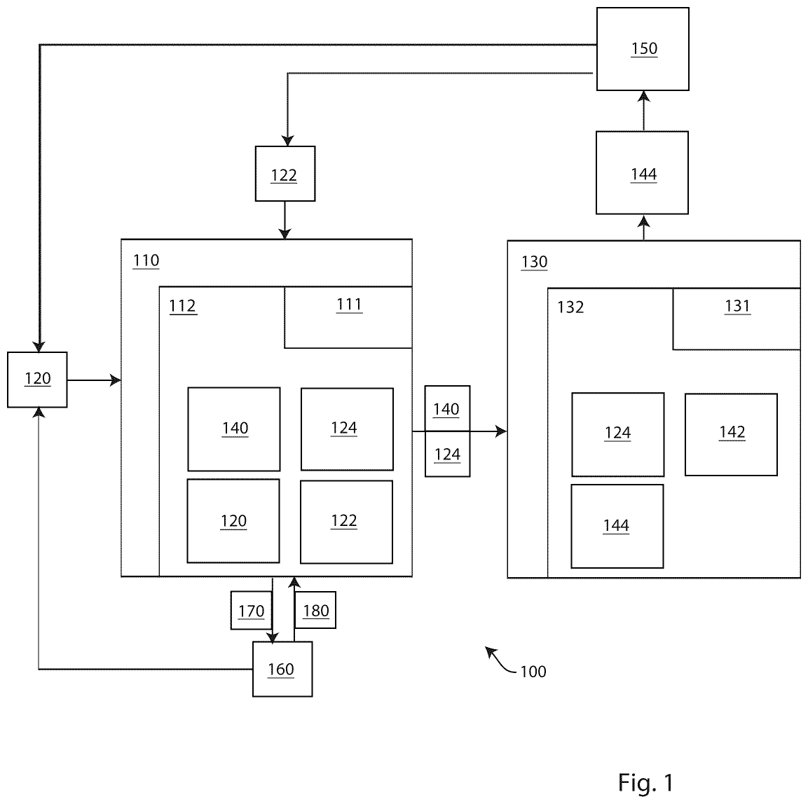

FIG. 1 depicts an exemplary embodiment of stream recommendation system 100 for providing a client with recommended items of clothing based on direct client data, stream data, and available inventory.

Stream recommendation system 100 includes a smart recommendation engine (SRE) 110 having a SRE software module 111 and an optional SRE storage 112. SRE 110 may be a processor or a combination of a processing system and a storage system.

SRE 110 receives direct client data 120 and inventory data 122 and analyzes the data using SRE software module 111 to generate an initial recommendation 124. Direct client data 120 includes all direct client input provided by each client to the system, all direct client feedback received from the client and put into the system by a personal shopper, all item information put into the system by a personal shopper regarding the items kept and returned by a client, and any other information received directly from the client. SRE unit 110 also passes a copy of direct client data 120, inventory data 122 and/or initial recommendation 124 to internal or external SRE storage 112 for permanent or temporary storage. Initial recommendation 124 may include, but is not limited to, pictures of articles of clothing in inventory recommended for the client, a listing of the attributes for articles of clothing determined to be recommended for the client, descriptions of the articles of clothing from inventory recommended for the client, and prices for the articles of clothing from inventory recommended for the client. The analysis and initial recommendation determination can be executed in a number of ways. In one embodiment, the determination is based not only on specific inventory items, but also based on the attributes of inventory items. For example, if the direct client data indicates that the client has previously received the same inventory item, it will be removed from the initial recommendation; if the direct client data indicates the client has previously returned the same inventory item, it will be removed from the initial recommendation; if the direct client data indicates that the inventory item is not available in the client's size, it will be removed from the initial recommendation; if the direct client data indicates that there are a number of attributes of the inventory item that the client does not like, the inventory item will be removed from the initial recommendation. In an embodiment, the total number of disliked attributes required for an inventory item to be removed from the initial recommendation may be a predetermined number. That predetermined number may be a set number (e.g. 2, 5, etc.) or it could be a percentage (such as 50%, 20%, 70%, etc. of the total number of attributes for the inventory item). In some embodiments, inventory attributes can generally be grouped into categories of sizing/fit and stylistic preferences.

Stream recommendation system 100 also includes at least one client desktop 160 remotely connected to the system used by a client for inputting direct client data 120. SRE 110 also displays stream pictures 170 to the client desktop 160 based on the initial recommendation 124, in one embodiment. Client desktop 160 may also provide input for rating 180 stream pictures 170 to SRE 110. SRE 110 passes a copy of rating 180 and stream pictures 170 to internal or external SRE storage 112 for permanent or temporary storage as client stream data 140. Stream pictures 170 are further described herein below as is rating 180.

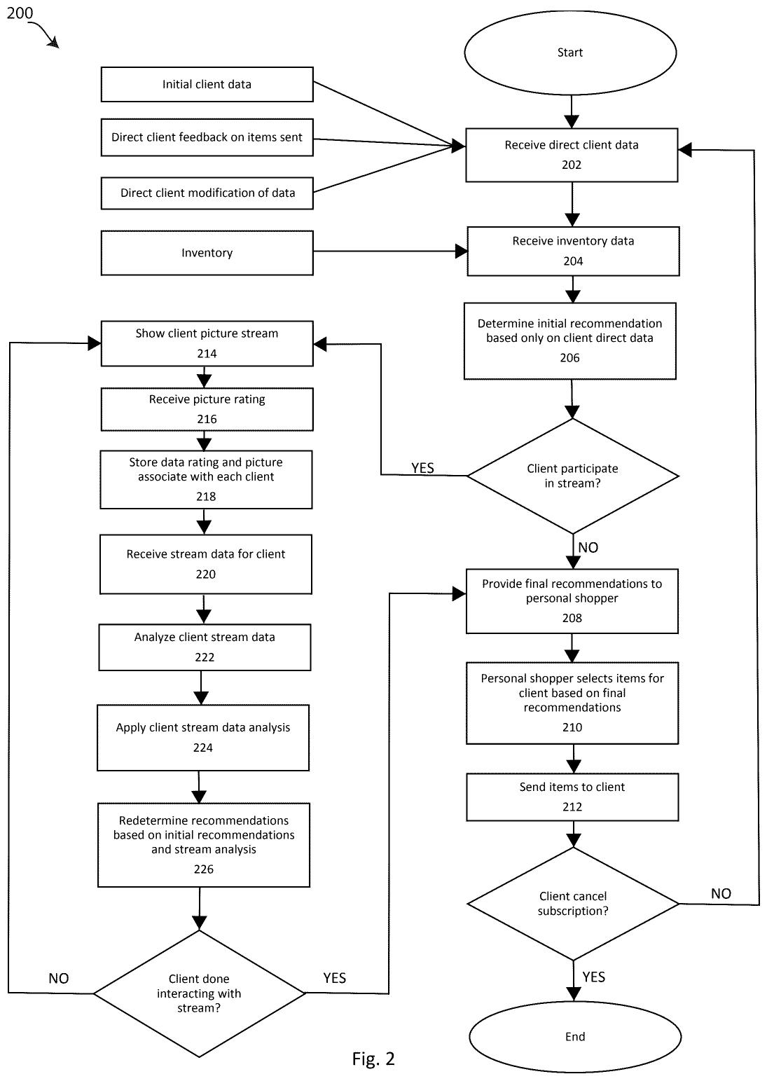

Stream recommendation system 100 also includes a final recommendation engine (FRE) 130 having a FRE software module 131 and an optional FRE storage 132. FRE 130 may be a processor or a combination of a processing system and a storage system. FRE 130 receives initial recommendation 124 from SRE unit 110. FRE 130 also receives client stream data 140 from SRE unit 110 and analyzes it using FRE software module 131 to generate client stream preferences 142. Using the client stream preferences 142 and the initial recommendation 124, FRE software module 131 analyzes the information and generates a final recommendation 144. Optionally, FRE 130 may pass a copy of initial recommendation 124, client stream preferences 142 and/or final recommendation 144 to internal or external FRE storage 132 for permanent or temporary storage. The analysis and final recommendation determination can be executed in a number of ways. In one embodiment, the final recommendation is determined based only on the client's stream data. For example, if the customer has requested product 1 in the past and product 2 has a similar profile to product 1 and was included in the initial recommendation, product 2 may be included in the final recommendation. As another example, if the customer has declined product 1 in the past and product 2 has a similar profile to product 1 and is included in the initial recommendation, it is unlikely that product 2 will be included in the final recommendation. It can be seen from these non-limiting examples that the more products a client rates the more granular of a preference determination the system can make. In other embodiments, the final recommendation may be determined not only on the client's stream data, but also using direct data and stream data from other clients. For example, if customer X has similar direct data and/or stream data to customer Y, and customer X has purchased product 1, the system may include product 1 as a final recommendation for customer Y if product 1 was part of the initial recommendation. In embodiments where other client's direct data and/or stream data is incorporated into the final determination analysis, this data may also influence the final determination regarding whether certain items should be included in the final recommendation if other certain items are included in the final recommendation. For example, if product 1 is frequently requested and kept by customers, but product 2 is frequently declined or returned by the same customers, the system may determine that customers who request product 1 will likely return product 2 and not include that product in the final recommendation. As another example, if product 1 is frequently requested and kept by clients and product 2 is also frequently requested and kept by the same clients, then the system may determine that if the final recommendation includes product 1, it should also include product 2, provided product 2 is included in the initial recommendation. In embodiments where other client's direct data and/or stream data is incorporated into the final determination analysis, this data may also influence the final determination for a customer who has never used the stream. Additional details on how the rating analysis is implemented in different embodiments can be found herein below in the description of FIG. 2.

Stream recommendation system 100 also includes at least one personal stylist desktop 150 used by the personal stylists for viewing final recommendations 124. Personal stylist desktop 150 may also provide input for updating direct client data 120 and inventory data 122 to SRE 110.

FIG. 2 depicts a flowchart of an exemplary embodiment of method 200 for providing recommended items of clothing to a client based on direct client data and stream data.

At step 202 the system receives direct client data. The direct client data includes the initial data and preferences received from the client when the client enrolled in the subscription, any direct modifications the client has made to the initial data and preferences, any direct client feedback received from the client regarding items received, and information on items kept and returned. At step 204 the system receives inventory data on the available inventory of items. It should be understood that steps 202 and 204 could happen in reverse order, simultaneously, or almost simultaneously. After receiving the direct client data (step 202) and the inventory data (step 204), the system analyzes the client data and inventory data to make an initial determination on which items in inventory are recommended for the client (step 206).

After enrolling in the subscription and the system makes the first initial determination (step 206), the system offers the client access to the stream. The stream is part of the system where clients can rate pictures of articles of clothing. Clients can access the stream to rate articles of clothing at any time after the first initial determination is made by the system in step 206. If the client chooses to access the stream, the client will be shown a picture of an article of clothing (stream pictures 170) at step 214. The pictures may be of a single article of clothing or multiple articles. The article(s) may be on a model or laid out. The picture could be displayed on the screen as a picture alone or could be displayed with additional information such as a title, a description of the article, price of the article, etc. The picture could be a series of pictures shown in such a way that the client can scroll through and determine which pictures the client wants to rate. In embodiments, the pictures shown to the client are based, at least in part, off of the initial determination in step 206. In embodiments, the pictures shown to the client are based, at least in part, off of all previous ratings provided by the client. In embodiments, the pictures shown to the client are based, at least in part, off of previous ratings provided by the client and other clients. For example, items with a high number of positive rankings might be presented to a client before items with a low number of positive rankings or items with a high number of negative rankings. In embodiments, the pictures shown to the client are based, at least in part, on rating types of only request and decline ratings provided by the client. In embodiments, the pictures shown to the client are based, at least in part, on rating types of only request and decline ratings provided by the client and other clients. In still further embodiments, the pictures shown to the client are based, at least in part, on any compatible combination of the above embodiments. In an embodiment, the pictures shown to the client are based on nothing more than available inventory. The pictures shown to the client may evolve each time after stream pictures are rated by the client. Next the system receives the client's rating for the picture (step 216). The rating could be a Boolean rating such as like or dislike, request or decline, or the like. The rating could also be a scale rating wherein the user rates the degree to which they like or dislike the article. For example, the scale could be a rating of 1-5 where 5 is like the most and 1 is dislike the most and 3 is neutral. The rating received could be more than one rating if the client is shown and rates a series of pictures. In embodiments, engagement in the stream may be analyzed and used to determine client satisfaction with the service and the likelihood the client will remain with the service. In embodiments, engagement in the stream may also be analyzed and used in marketing decisions. For example, it may be determined that clients who engage heavily in the stream should be marketed to differently or using different mechanisms than clients who do not engage heavily in the stream. In embodiments, all of the different types of ratings made by clients may influence inventory decisions. In other embodiments, only rating types of request and decline made by clients may influence inventory decisions.

As indicated above, each available rating will be treated and weighed by the system differently. For example, in embodiments where the stream provides the ability to use Boolean ratings of like, dislike, request and decline, the system may analyze a rating of request based on different factors than the system analyzes a rating of like such that an item rated as request might be treated by the stream data analysis as if the customer ordered that item. Meaning that the customer not only liked or found the item appealing, but also was willing to actually purchase that item at that time. Therefore, the rating of request provides the system with significantly different information than a rating of like. A customer might rate an item as “like” even though they do not necessarily want to purchase it if it is available. The customer might like the color, might like the style, might like the item because they already own a similar item and do not necessarily want another of the same item. “Likes” still provide the system with valuable information and the stream data analysis would be weighted and analyzed accordingly. A rating of request is a strong, direct message to the system that the customer wants that specific item, in that specific color, at that specific price, at that specific time. The system would analyze the stream data for that item accordingly and include that item in the final recommendation, if it is in the inventory, with a designation that the item is rated as requested. In embodiments, even if the requested item is not in stock, the system will treat the requested item similar to past purchases for making future final recommendations to the personal shopper.

Further, each available rating may cause different effects throughout the system and process. For example, in embodiments where the stream provides the ability to use Boolean ratings of like, dislike, request, and decline, a rating of request is not only analyzed differently than a rating of like in the stream data analysis, but a rating of request also serves to request that specific item such that if the item is available in inventory at the time of the next delivery to that customer. Another example is the rating of decline. A rating of decline not only is not only analyzed differently than a rating of dislike, it also removes the item entirely from the pool of possible recommendations for that client. This is unlike dislike where if a customer rates an item as dislike, there is still the possibility that the system will determine (based on all stream rating activity) that the item should still be recommended for the customer. Such a circumstance may occur if the item rated as dislike has numerous attributes associated with items that the customer has either liked, requested, or kept. In that circumstance, the system may analyze the stream data and determine that the disliked item should still be recommended to the customer. Whereas, a declined item will never be recommended even if the customer had previously requested an item with nearly identical attributes as the declined item.

In other embodiments where the only options for rating may be request/decline, like/dislike, request/dislike, like/decline; the system will maintain the distinct analysis and weighting as described above. Therefore, in an embodiment where the only options are request/decline, it would be expected that customers might rate less items in the stream (because they are actually requesting that the item be delivered or they are removing that item as an option permanently); however, the weight and analysis of the ratings will have the same effect on the system as those embodiments that have more rating options. In embodiments where the rating is a sliding numerical scale, the highest rating could also correspond with being weighted and analyzed similar to the request rating and the lowest rating could correspond with being weighted and analyzed similar to the decline rating.

After receiving the client rating at step 216, the system stores the stream data individually for each separate client (step 218). The stream data includes the client rating and the picture associated with the rating. At step 220, the system receives all stream data for all rated pictures for the client. The system analyzes all of the stream data for the client at step 222. The analysis of stream data makes additional determinations of a client's preferences and dislikes based on how the client rates the articles of clothing they are shown. After the system analyzes the stream data at step 222, it applies the stream analysis to the initial determination (step 206) and makes a redetermination of the recommendation at step 226. The redetermination of the recommendation is based off of the initial determination and the stream analysis is incorporated thereto. Therefore, the more pictures a client rates, the more information the system has on a client's preferences and the more accurately the system can model a client's likes and dislikes. If the client chooses to continue accessing the stream, the system will continue to repeat steps 214 through 226 as described above until the client discontinues accessing the stream.

At step 208, the system provides the personal shopper with a final recommendation on which items in inventory are recommended for the client. If the client has never chosen to participate in the stream and there is no stream data for the client, the final recommendation will be the initial determination made at step 206. However, if the client has ever participated in the stream and there is any stream data for the client, the final recommendation will be the redetermined recommendation made at step 226. The final recommendation may be provided to the personal shopper in any order. The final recommendation may be provided to the personal shopper such that the item that most closely matches the client's preferences is listed at the top and the item that least closely matches the client's preferences is listed at the bottom. The final recommendation may be provided to the personal shopper such that the item that most closely matches items the client has already kept is listed at the top and the item that least closely matches items the client has already kept is listed at the bottom. If, since the last shipment, the client has rated an item as “request” on the stream, the system will clearly indicate to the personal shopper with the final recommendation that the item has been requested. The final recommendation may also contain an indication of items specifically declined so that the personal shopper can ensure they do not ship a declined item to the client. In embodiments, requested items are prioritized based on how many requests the customer has made. As a non-limiting example, if two clients request the same item and only one of that item is available in inventory, the customer who has only requested an item once may receive preference over the client who has made ninety-nine requests.

At step 210 the personal shopper selects items to be sent to the client based on the final recommendation of the system. If the final recommendation contains an item requested by the client, the personal shopper will be instructed by the system to include the requested item in the shipment, provided the item is available in inventory. The personal shopper sends the items to the client at step 212. Once the client receives the items the client determines which items to keep and which items to send back. The client has a set time period within which to return any items not wanted. Any items not returned by the deadline are presumed to be kept. Information on the items kept and sent back are recorded in the system and modify the client's direct data. The client may also provide direct feedback regarding the items sent. The direct feedback is recorded in the system and modifies the client's direct data. Further, the client may access his/her direct data at any time and make modifications. If the client does not choose to end the subscription, the process continues to repeat from step 202 through step 212. The process repeats at a predetermined time set by the client. For example, the client could choose to have items delivered twice per month, once per month, once every three months, etc. The client can directly change the time between deliveries at any time. Further the client can choose to access the stream at any time while the client is subscribed to the system. Any images rated before the predetermined delivery time will be included in the redetermination of the final recommendation. If the client decides to end the subscription, the process ends and the system is notified to stop creating recommendations for the client.

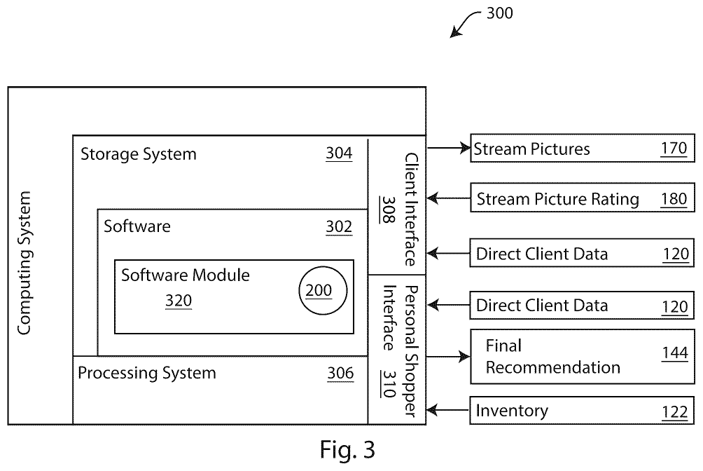

FIG. 3 depicts an exemplary embodiment of system 300 for providing a client with recommended items of clothing based on direct client data, stream data, and available inventory.

System 300 is generally a computing system that includes a processing system 306, a storage system 304, software 302, a client interface 308, and a personal shopper interface 310. Processing system 306 loads and executes software 302 from the storage system 304, including a software module 320. When executed by computing system 300, software module 320 directs the processing system 306 to operate as described in herein in further detail in accordance with the method 200.

Computing system 300 includes a software module 320 for performing the function of SRE software module 111 and FRE software module 131. Although computing system 300 as depicted in FIG. 3 includes one software module 320 in the present example, it should be understood that more modules could provide the same operation. Similarly, while the description as provided herein refers to a computing system 300 and a processing system 306, it is to be recognized that implementations of such systems can be performed using one or more processors, which may be communicatively connected, and such implementations are considered to be within the scope of the description. It is also contemplated that these components of computing system 300 may be operating in a number of physical locations.

The processing system 306 can comprise a microprocessor and other circuitry that retrieves and executes software 302 from storage system 304. Processing system 306 can be implemented within a single processing device but can also be distributed across multiple processing devices or sub-systems that cooperate in existing program instructions. Examples of processing systems 306 include general purpose central processing units, application specific processors, and logic devices, as well as any other type of processing device, combinations of processing devices, or variations thereof.

The storage system 304 can comprise any storage media readable by processing system 306, and capable of storing software 302. The storage system 304 can include volatile and non-volatile, removable and non-removable media implemented in any method or technology for storage of information, such as computer readable instructions, data structures, program modules, or other data. Storage system 304 can be implemented as a single storage device but may also be implemented across multiple storage devices or sub-systems. Storage system 304 can further include additional elements, such as a controller capable of communicating with the processing system 306.

Examples of storage media include random access memory, read only memory, magnetic discs, optical discs, flash memory, virtual memory, and non-virtual memory, magnetic sets, magnetic tape, magnetic disc storage or other magnetic storage devices, or any other medium which can be used to store the desired information and that may be accessed by an instruction execution system, as well as any combination or variation thereof, or any other type of storage medium. In some implementations, the storage media can be a non-transitory storage media. In some implementations, at least a portion of the storage media may be transitory. Storage media may be internal or external to system 300.

Personal shopper interface 310 can include one or more personal shopper desktops 150, a mouse, a keyboard, a voice input device, a touch input device for receiving a gesture from a user, a motion input device for detecting non-touch gestures and other motions by a user, and other comparable input devices and associated processing elements capable of receiving user input from a personal shopper. Output devices such as a video display or graphical display can display final recommendation 144, personal shopper desktop 150, or another interface further associated with embodiments of the system and method as disclosed herein. Speakers, printers, haptic devices and other types of output devices may also be included in the personal shopper interface 310. A personal shopper or other staff can communicate with computing system 300 through the personal shopper interface 310 in order to view final recommendation 144, enter inventory data 122, direct client data 120, or any number of other tasks the personal shopper or other staff may want to complete with computing system 300.

As described in further detail herein, computing system 300 receives and transmits data through client interface 308. In embodiments, the communication interface 308 operates to send and/or receive data, such as, but not limited to, direct client data 120, stream picture rating 180, and steam pictures 170 to/from other devices and/or systems to which computing system 300 is communicatively connected, and to receive and process client input, as described in greater detail above. The client input can include direct client data 120 and stream picture rating 180, as further described herein. The output can include stream pictures 170, as further described herein.

In the foregoing description, certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

What is claimed is:

1. A method for determining and delivering client style preferences based on direct client data, stream data and available inventory to a client, comprising:
receiving a set of direct client data at a smart recommendation engine (SRE);
receiving a set of inventory data at the SRE;
performing an analysis of the set of inventory data to make a determination of an initial recommendation based on the set of direct client data using a SRE software module on the SRE;
providing access to a rating system to the client, wherein the rating system, using the SRE, displays at least one image of at least one article to the client for the client to rate;
providing the rating system with the initial recommendation;
receiving, at the rating system, the rating for each displayed article that the client rates;
storing all received ratings and displayed articles associated with the rating for the client as a set of client stream data;
receiving the set of client stream data for the client at a final recommendation engine (FRE);
receiving the initial recommendation at the FRE;
performing an analysis of the initial recommendation to make a determination of a final recommendation based on the set of client stream data for the client using a FRE software module on the FRE, wherein each time the client provides a new rating from the rating system, the final determination will be further refined by the new rating;
displaying the final recommendation in a graphical user interface to a personal shopper;
selecting, by the personal shopper, a set of inventory items to send to the client based on the final recommendation; and
sending the selected set of inventory items to the client.

2. The method of claim 1, wherein the rating includes a request option, wherein use of the request rating includes the article in the final recommendation and designates the article as requested for final recommendation analysis.

3. The method of claim 2, further comprising sending the requested article to the client as part of the set of inventory items, when the final recommendation includes a requested article and the requested article is in inventory.

4. The method of claim 1, wherein the rating includes a decline option, wherein use of the decline rating prohibits the article from being included in the final recommendation and designates the article as declined for final recommendation analysis.

5. The method of claim 1, wherein the direct client data includes a set of initial client data provided by the client.

6. The method of claim 1, further comprising receiving a direct client feedback on the set of inventory items sent, wherein the direct client feedback is incorporated into the direct client data.

7. The method of claim 1, further comprising receiving data on the set of inventory items kept by the client and data on the set of inventory items returned by the client, wherein the data is incorporated into the direct client data.

8. The method of claim 1, wherein the at least one image of the at least one article displayed to the client by the rating system is determined, at least in part, based on the initial recommendation.

9. A computerized method for determining client style preferences based on direct client data, stream data and available inventory to a client, comprising:
receiving a set of direct client data at a smart recommendation engine (SRE);
receiving a set of inventory data at the SRE;
performing an analysis of the set of inventory data to make a determination of an initial recommendation based on the set of direct client data using a SRE software module on the SRE;
receiving the initial recommendation at a final recommendation engine (FRE);
receiving a set of client stream data for the client at the FRE, wherein the set of client stream data is a set of ratings provided by the client for a set of articles and the set of articles corresponding to the set of ratings;
performing an analysis of the initial recommendation to make a determination of a final recommendation based on the set of client stream data for the client using a FRE software module on the FRE; and
displaying the final recommendation in a graphical user interface to a personal shopper.

10. The method of claim 9, further comprising selecting, by the personal shopper, a set of inventory items to be sent to the client based on the final recommendation.

11. The method of claim 9, further comprising sending the selected set of inventory items to the client.

12. The method of claim 9, further comprising receiving at least one inventory item of the set of inventory items back in inventory from the client, wherein receiving the inventory item back in inventory from the client indicates the client's return of the item, further wherein the client's return of the item is included in the direct client data for the initial recommendation.

13. The method of claim 9, wherein a rating option includes a request option, wherein use of the request rating adds the article to the final recommendation and designates the article as requested for final recommendation analysis.

14. The method of claim 13, further comprising sending the requested article to the client as part of a set of inventory items, when the final recommendation includes a requested article and the requested article is in inventory.

15. The method of claim 9, wherein a rating option includes a decline option, wherein use of the decline rating prohibits the article from being added to the final recommendation and designates the article as declined for final recommendation analysis.

16. The method of claim 9, wherein the direct client data includes a set of initial client data provided by the client, a set of direct client feedback on the set of inventory items sent, and a set of data on the articles kept by the client and the articles returned by the client.

17. The method of claim 9, wherein each time the client provides a new rating, the stream data will be updated and a new final recommendation will be determined.

18. An automated computer system for determining client style preferences based on direct client data, stream data and available inventory to a client, comprising:
a processor;
a display with a graphical user interface for displaying a final recommendation to a personal shopper; and
a non-transitory computer readable medium programmed with computer readable code that upon execution by the processor causes the processor to:
receive a set of direct client data at a smart recommendation engine (SRE);
receive a set of inventory data at the SRE;
perform an analysis of the set of inventory data to make a determination of an initial recommendation based on the set of direct client data using a SRE software module on the SRE;
receive the initial recommendation at a final recommendation engine (FRE);
receive a set of client stream data for the client at the FRE, wherein the set of client stream data is a set of ratings provided by the client for a set of articles and the set of articles corresponding to the set of ratings;
perform an analysis of the initial recommendation to make a determination of a final recommendation based on the set of client stream data for the client using a FRE software module on the FRE; and
display the final recommendation in a graphical user interface to a personal shopper.

19. The system of claim 18, wherein a rating option includes a request option, wherein use of the request rating adds the article to the final recommendation and designates the article as requested for final recommendation analysis.

20. The system of claim 18, wherein the direct client data includes a set of initial client data provided by the client, a set of direct client feedback on the set of inventory items sent, and a set of data on the articles kept by the client and the articles returned by the client.
